(19) United States
(12) Patent Application Publication
(10) Pub. No.: US 2011/0024341 A1
(43) Pub. Date: Feb. 3, 2011

(54) Rainwater Catchment System

(75) Inventor: Charleen Catt Lyon, Cincinnati, OH (US)

Correspondence Address: WOOD, HERRON & EVANS, LLP, 2700 CAREW TOWER, 441 VINE STREET, CINCINNATI, OH, 45202, US

(73) Assignee: CATT LYON DESIGN, INC., Cincinnati, OH (US)

(21) Appl. No.: 12/847,413

(22) Filed: Jul. 30, 2010

Related U.S. Application Data
(60) Provisional application No. 61/229,808, filed on Jul. 30, 2009.

(51) Int. Cl. C02F 1/00; B01D 35/02; B23P 17/04

(52) U.S. Cl. 210/170.03; 29/401.1

(57) ABSTRACT

A rainwater catchment system uses a basket-like strainer removably received within an opening formed in a lid of a conventional container, such as a 55-gallon plastic drum. The strainer includes an upper flange or rim, a side wall, and a bottom with a reinforcing web and a mesh. When the container is placed so that a downspout from a roof is directed toward the strainer, the water that flows out of the downspout flows into the strainer, through the mesh, and into the container where it is collected for future use. The removability of the strainer facilitates cleaning of the mesh. The reinforcing web, preferably with radially directed spokes, which may be curved to define a fan blade shape, helps to support the mesh so to better accommodate high volume water flow while also filtering out unwanted debris. This catchment system can be easy made out of a conventional container, such as a 55-gallon plastic drum, or a 35-gallon garbage can, by forming the hole within the conventional lid. Alternatively, a replacement lid, essentially an adapter, can be supplied in combination with the strainer to fit on the top of a conventional container, thereby to further facilitate home use.

### RELATED APPLICATION

The present application claims priority to U.S. Ser. No. 61/229,808 filed Jul. 30, 2009, the disclosure of which is hereby incorporated by reference herein, in its entirety.

### FIELD OF THE INVENTION

This invention relates to a rain barrel used in a rainwater catchment system, and more particularly, to a structure that cooperates with a rain barrel to facilitate the simple and cost-effective harvesting of rainwater.

### BACKGROUND OF THE INVENTION

Rainwater harvesting, in one way or another, has been done for centuries. This practice has recently become more common practice due to concern for environment and the desire to conserve resources. For instance, a rainwater harvesting system, in combination with a home's gutter and downspout system, can enable a homeowner to divert rainwater into a series of rain barrels and either store more water than the typical rain barrel, or, irrigate different parts of the garden simultaneously.

Significant amounts of water can be collected from rooftops. For example, 1000 square feet of catchment area can collect in total, approximately 600 gallons of rainwater for every inch of rainfall. Based on this formula, a home with a 36′×46′ footprint has at least 2,000 square feet catchment area and typically, this rooftop can capture 1200 gallons of rainwater per every 1″ of rain. In a climate that yields 25″ annual rainfall per year, that is potentially 30,000 gallons of free water.

In addition to saving money on water bills, rainwater harvesting relieves the strain on municipal sewer systems, which can be overwhelmed during heavy thunderstorms, thus causing stream pollution. Rainwater collected or harvested is not potable and is intended only for irrigating the garden and landscaping around the home. Nonetheless, rainwater harvesting also relieves the demand on potable water supplies, eliminating the energy and expense of treating and pumping potable water, for irrigation purposes.

Despite these objective benefits and costs savings, many homeowners do not harvest rainwater at all, due to inconvenience or impracticalities, or perhaps simply because they do not know where to begin. Thus, there is a significant need to make it easier for homeowners to conveniently and inexpensively collect and use rainwater from their rooftops.

### SUMMARY OF THE INVENTION

This invention fulfills this need via a strainer, or basket, that is removably held within an opening in a lid of a container, wherein the container may be a conventional plastic drum.

According to one aspect of the invention, the strainer is sized and shaped to accommodate an internal edge that defines the opening in the lid. The strainer includes a reinforced mesh located below the opening. The reinforced mesh allows rainwater to pass therethrough, when the container is located such that the opening is in the flow path of a water downspout. The mesh also filters debris from the rainwater as it passes.

According to another aspect of this invention, the rain barrel used with the strainer of this invention can be made of a variety of ready-made or custom designed containers, such as galvanized steel, painted steel, stainless steel, aluminum, fiberglass, and plastic. In addition to various materials, with this invention a homeowner can implement rainwater harvesting with a variety of containers of various size and shape, including 30-gallon metal trashcans, 55-gallon drums, fiberglass containers, aluminum, stainless steel containers and even some types of plastic containers. This disclosure focuses on ready-made containers, such as a 55-gallon plastic drum or a 30-gallon metal trashcan, because such containers are ubiquitous items produced in mass quantities. As such, these items have the greatest potential for achieving a relatively low-cost and convenient rainwater catchment system, and certainly at a lower cost than the typical rain barrels currently on the market.

According to a preferred embodiment, the strainer is essentially a basket comprised of a body made in one piece by injection molding using a single cavity mold, the body having a top flange, a peripheral side wall and a bottom. The strainer is preferably circular in shape, and the bottom includes reinforcement material, which may be radially directed spokes of plastic webbing, possibly even curved spokes. This reinforcement material at the bottom of the strainer provides extra structure to hold the mesh filter in place. The mesh filter could be a disk of pre-cut mesh that is heat-sealed to either the upper or the lower surface of the reinforcing structure. However, according to a preferred embodiment, the mesh is laid in the mold, and the body is formed around the mesh. The unique design of the strainer, including its wide flange at the top, its reinforced web design at the bottom, and the way it fits into the lid, prevents debris and insects from entering the collection vessel. This is an advantageous feature, as most rain barrels on the market today do not provide protection from debris and insects entering the containment vessel. This size, shape and structure of strainer also makes it easy to remove and clean.

According to yet another aspect of the invention, a rain barrel for rainwater harvesting can be adapted from a conventional or a “classic” rolled metal 30-gallon trashcan. Moreover, this method can be applied similarly to other conventional containers. For instance, using a 30-gallon metal trashcan, a large hole can be cut out of the lid, to accommodate the strainer. Then, two holes can be cut into the “barrel” wall, to accommodate the plumbing assemblies. And thirdly, in the case of the trashcan, the inside bottom edge and the handles should be water sealed, for instance with a bead of silicon to make the can watertight. Generally, containers without seams would not need this step. Though the stampings and details of the various 30-gallon metal trashcans on the market vary slightly, any type of trashcan should work.

One simpler way to practice the invention, which is applicable to any style container, is to replace the original lid with a modified lid having a pre-cut opening, with the strainer sized and shaped to fit into the opening. This approach is best suited for containers of conventional size and shape, which have conventionally sized upper ends. This approach is also better suited to those who are not do-it-yourselfers, who would not be inclined to cut a hole in a garbage can lid, or the lid of another type of container.

The invention contemplates the connection of plumbing assemblies to the rain barrel, so as to function universally with all standard hose couplings and related fittings. With two assemblies per barrel, the operator is able to establish the specific flow options to suit his or her irrigation needs. Both plumbing assemblies are equipped with on/off valves, to provide additional utility when controlling water flow. Most rain barrels on the market do not offer two fully functional plumbing assemblies.

These features will be more readily understood in the context of the following Figures.

### BRIEF DESCRIPTION OF THE FIGURES

FIG. 1 is a top view of a strainer in accordance with a preferred embodiment of this invention.

FIG. 2 is a side view of the strainer shown in FIG. 1.

FIG. 3 is a bottom view of the strainer shown in FIG. 1.

FIG. 3A is a perspective view of the strainer shown in FIG. 1.

FIG. 3B is an axial cross-section view of the strainer of FIG. 1.

FIG. 4 is a top view of the strainer shown in FIG. 1, but received within a lid of a container.

FIG. 5 is a longitudinal cross-sectional view of the strainer, lid, and container shown in FIG. 4, but located alongside a house, relative to a downspout.

FIG. 6 is a side view of a strainer, lid, and container according to another aspect of the invention, wherein the strainer is offset from the center axis of the container.

FIG. 7 is a top view which schematically shows the lid of FIG. 6, with the opening offset.

FIG. 8 is a longitudinal cross-sectional view, similar to FIG. 5, of the strainer, lid, and container shown in FIG. 6.

FIG. 9 is a top view, similar to FIG. 7, but also showing the strainer held by the lid in the offset position.

FIGS. 10, 11, and 12 are analogous to FIGS. 6, 8, and 9, respectively, with a conventional 55-gallon metal drum serving as the container.

FIGS. 13, 14, 15, and 16 are analogous to FIGS. 6, 7, 8, and 9, respectively, with a conventional garbage can serving as the container, and the strainer located in the center thereof.

FIGS. 17 and 19 show additional aspects of the present rainwater catchment system, in modular form, and particularly the capability to connect additional rain barrels to enhance versatility in rainwater storage and use.

FIG. 18 is an exploded view of one embodiment of a plumbing assembly usable with the invention.

FIGS. 20 and 21 are similar to FIGS. 1 and 3, respectively, but show a second preferred embodiment of the basket-like strainer of the present invention.

### DETAILED DESCRIPTION OF THE PREFERRED EMBODIMENTS

FIG. 1 shows a plan view of a first embodiment of a basket-like strainer 12, which is one part of a rainwater catchment system (10) (not shown) of the present invention. The strainer 12 includes an upper flange 20, which is preferably circular in shape. If desired, a product logo can be incorporated into the flange 20, for instance by embossing. The strainer 12 includes a bottom end 21 which preferably includes reinforcement support structure 22 and a mesh 24, and side wall 26 which is preferably tapered.

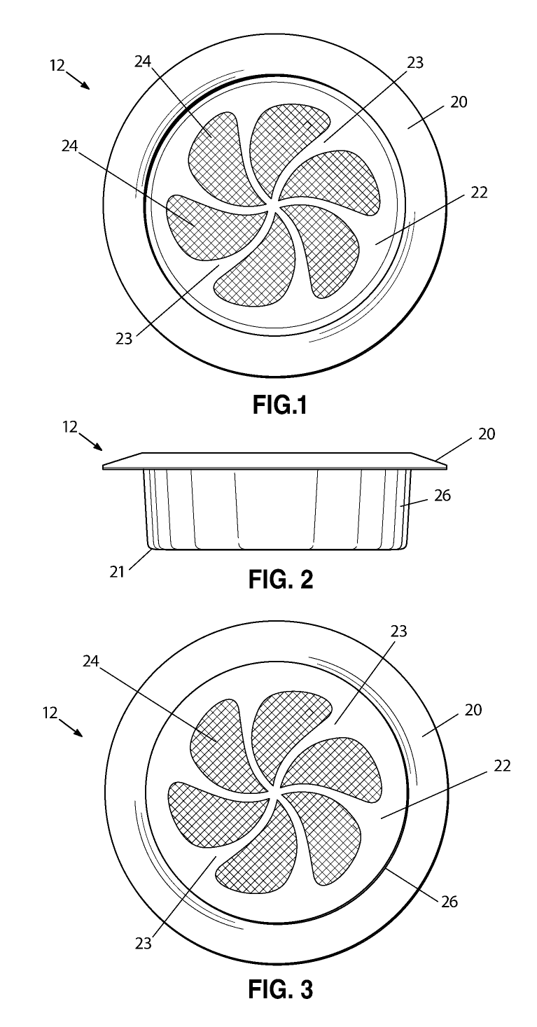

As best shown in FIG. 2, the sidewall 26 which interconnects upper flange 20 with the reinforcing structure 22 and the mesh 24. The reinforcement structure 22 preferably includes radially directed spokes 23, or ribs, which may be curved in shape, as best shown in FIG. 1. This curved shape provides an aesthetically appealing look to the strainer 12, while also providing structural support for the mesh 24, to prevent rupture of the mesh 24. Preferably, the mesh 24 is a nylon 400 micron mesh that is placed in a single cavity mold used to make the body of the strainer 12, so that it becomes part of the bottom 21 of the strainer 12. Although this particular mesh size is suitable, it is to be understood that other mesh sizes would also work. While the strainer 12 can be formed in any number of ways, out of various materials, applicant believes that the best way to make the strainer 12 would be to use a polystyrene or a polypropylene with UV stabilization, and to injection mold the upper flange 20, the side wall 26, and the bottom 21 in a single cavity mold step, with the mesh 24 placed therein prior to injection, to create one integral piece. This results in the mesh 24 being encased within the reinforcing structure 22, on the top and the bottom of the mesh 24. Preferably, during the cooling of the strainer 12, the mesh 24 is pulled tight, to assure that it remains flat and in the desired plane.

As will be appreciated by those skilled in the art, the dimensions may vary. Nonetheless, applicant believes that an internal width of about 8½ inches is preferable, with the basket depth, i.e. the axial dimension of side wall 26, being about 3-4 inches. With this dimension, the “raindrop” shapes of the sections of mesh 24 are about 4 inches long and about 2 inches wide, at their widest point. But it should be recognized that other sizes and shapes would also work. Applicant believes that a company located in Eagle, Wis., named Plastic Molded Concepts, Inc., would be a suitable source for making the strainer 12 of this type.

The unique design of the strainer 12 of this invention keeps mosquitoes out of the collected rainwater. Many rain current barrels do not have mosquito protection. As a result, with such existing rain barrels, a homeowner would need to add chemicals to kill mosquito eggs. This is not necessary with the present design.

Also, the depth of strainer 12 allows water to pool therein while it is being strained. This ensures that the maximum amount of water is captured. Many current rain barrels do not provide a collection chamber. As a result, with the current rain barrels during a heavy downpour, much of the water runs off before it can be captured.

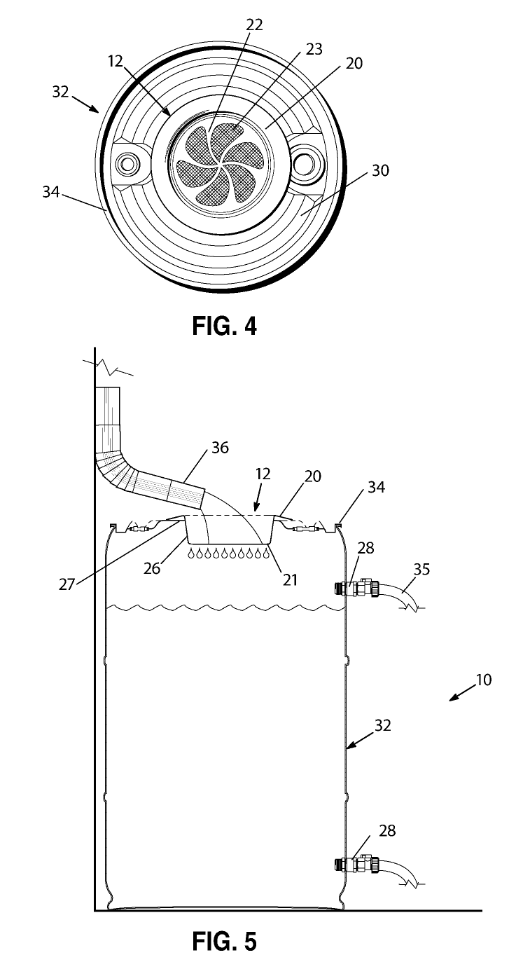

FIGS. 4 and 5 better show the use of the basket-like strainer 12 and a plumbing assembly 28 as part of the rainwater catchment system 10. More particularly, FIG. 4 shows the strainer 12 residing within a top end 30 of a container 32, with the top end typically defined by a lid 30. The container 32 also has an upper edge 34. In this view, the strainer 12 is located centrally, and is axially aligned with the longitudinal axis of the container 32.

FIG. 5 shows this container 32, or rain barrel, placed directly against the exterior wall of a house and underneath a downspout 36. When it rains, water flows off the roof, into the gutter and through the downspout 36. Instead of the water pouring from the downspout 36 into the sewer, the water flows into the strainer 12 held by the upper end 30 and collects in the barrel 32. As rainwater pours into the basket 12, the mesh 24 diffuses the water, thus eliminating splash back.

FIG. 5 also shows the opening 27 formed in the lid 30 at the upper end of the container 32, which defines the location of the strainer 12. Preferably, the opening 27 is circular in shape, and conforms to the shape of the flange 20, so that the flange 20 overlaps the opening 27 around the entire circumference. The taper of side wall 26 helps to center the strainer 12 within the opening 27, when the strainer 12 and the opening 27 are circular in shape.

The strainer 12 screens out debris such as dead leaves, twigs, and aggregate from deteriorating asphalt shingles. Because the basket 12 is so easy to remove, it is easy to clean. Most rain barrels currently on the market (typically at relatively high prices) do not provide an easy way to screen debris, much less provide a cleanable filter.

The strained rainwater collects in the barrel 32 until it fills up to the overflow plumbing assembly 28, near the rim 34. Powered by gravity, the water will flow through the overflow assembly into a hose 35, provided the corresponding valve is open. Depending on where the hose 35 leads, the water will flow to the lowest point. The rainwater may flow to another barrel, if provided, or into a hose which goes to the garden.

The size of the strainer 12 is big enough so that when it is removed from the lid 30, it affords access to the barrel interior so that the interior can be scrubbed out with a long-handled brush. Thus, the size and the shape of the strainer 12 and the opening 27 facilitate cleaning of the container 32. Most plastic rain barrels currently on the market have a fixed lid that cannot be removed easily, especially when there is water in the container, as the lid helps to provide some stability for the otherwise floppy plastic barrel. These current structures make cleaning the interior very difficult, and often necessitate the use of harsh chemicals to get rid of algae and mold. The present invention mitigates these problems.

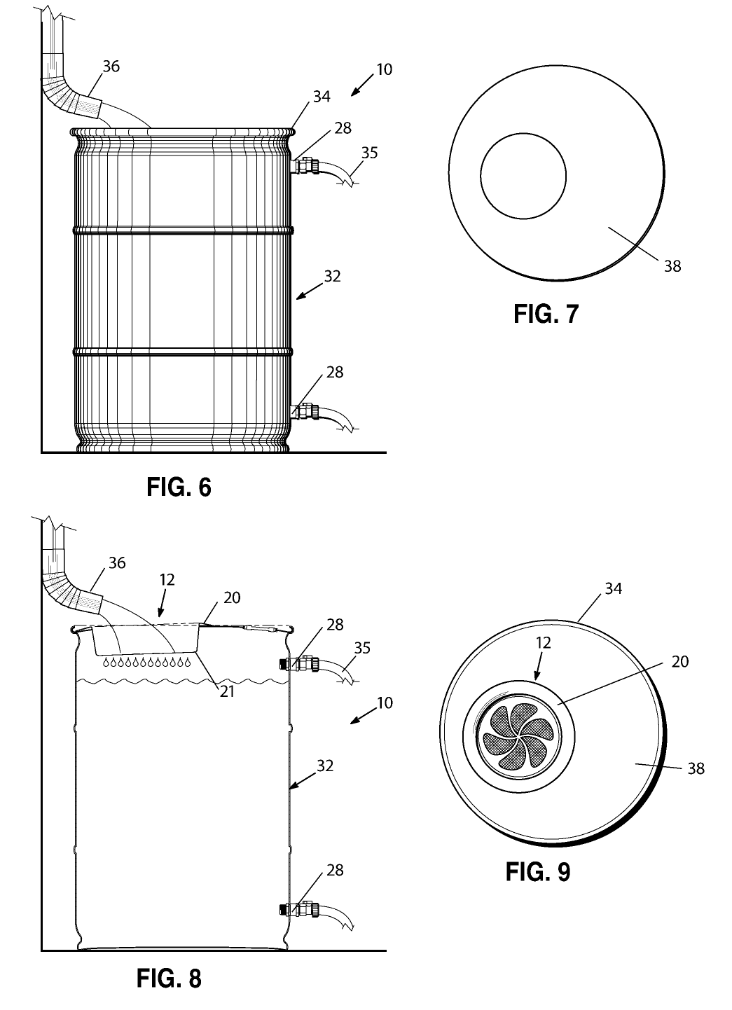

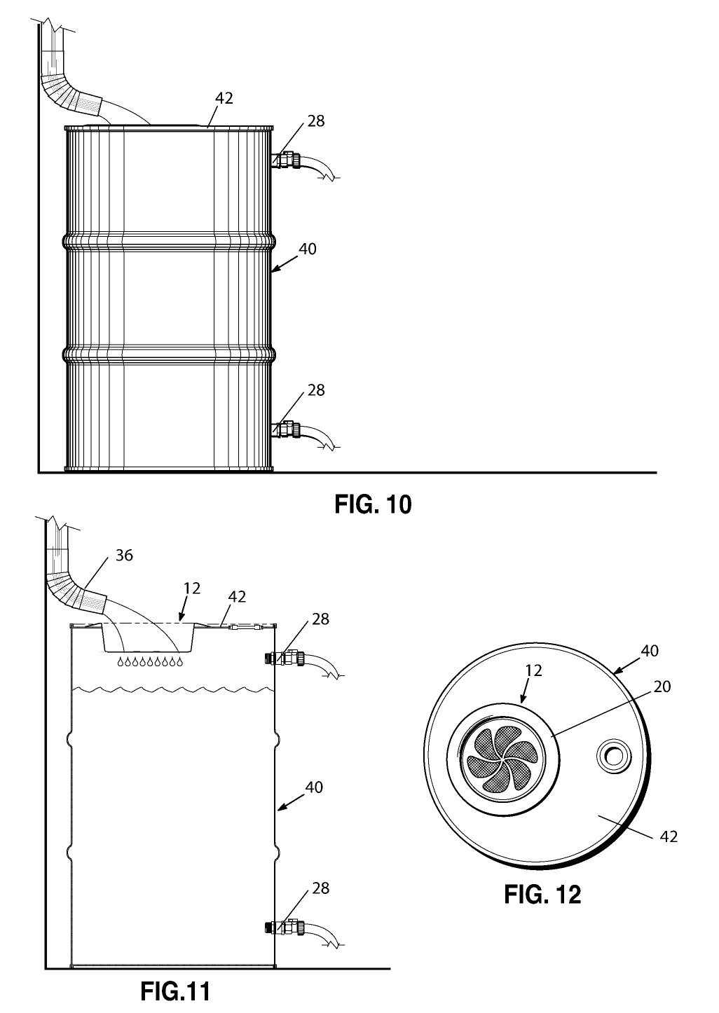

The location of the strainer 12 related to the container 32 is also designed to make it easier for the homeowner to use. That is, the location of the strainer 12 may be centered or off-center within a particular lid 30, as shown in FIGS. 6, 7, 8, and 9, and also in FIGS. 10, 11, and 12. Although the strainer 12 location may vary depending on the container 32, the distance from the wall 30 of the house remains the same, because this wall-to-house distance is based on the typical length of a downspout 36 elbow. By using an offset location for the strainer 12, the present invention can minimize the need for awkward extensions of the downspout 36.

The invention also contemplates the use of an adapter at the top end 30 of a conventional open-ended drum, to eliminate the need to cut a hole cut in the conventional lid. More particularly, with this adapter lid 30/strainer 12 approach, the user can substitute an adapter lid 30 for the original lid of the drum, wherein the adapter lid 30 is already sized and shaped to accommodate the conventional drum 32 and the strainer 12. With this approach, the adapter lid 30 and the strainer 12 could be sold as a package, and the user would not need to cut a hole in the conventional lid. The adapter lid 30 would preferably be sized and shaped to lock into place with the drum's 32 existing locking ring (not shown).

The benefits of this modular rainwater harvesting system 10 are numerous. In addition to the flexibility and modularity of the design, these components work together to deliver functionality at a relatively low cost. As a result, the rainwater collection system 10 of the present invention is a much more economical solution than other rainwater harvesting systems currently on the market.

For instance, ready-made containers such as 55-gallon plastic drums are ubiquitous items produced in mass quantities. As such, they have a lower unit cost than a plastic drum manufactured specifically for use as a rain barrel. By using an existing conventional plastic drum, this invention keeps the overall cost of the system 10 relatively low. Such conventional plastic drums, with a few modifications, serve well as the container 32 of the system 10. Also, a conventional 55-gallon plastic drum can be easily fitted with the plumbing assemblies 28, and a hole 27 cut into the lid 30 or top end 30 thereof, to accommodate the strainer 12.

Another benefit of using ready-made containers is directly to the environment. Because of the abundance of used 55-gallon plastic drums, this invention will helps prevent conventional drums from becoming a waste product.

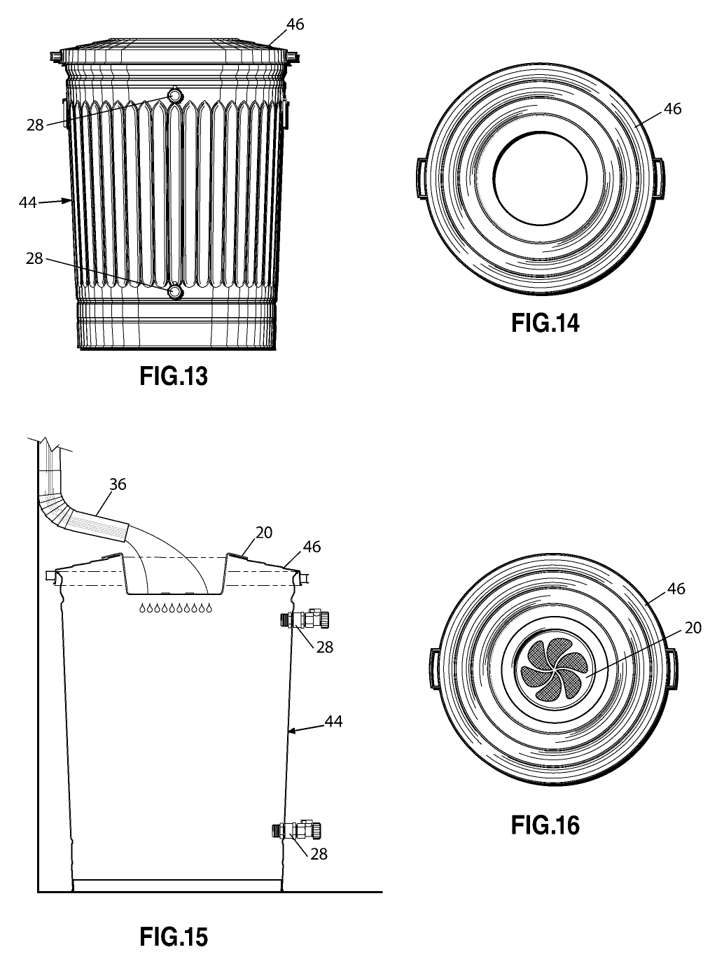

FIGS. 13, 14, 15, and 16 show that these same principles apply to a conventional, 35-gallon metal garbage can 44. This FIG. shows the strainer 12 located in the center of the container 44, with a hole 27 cut in the lid 46 thereof. Notably, the bottom of the can 44 should be sealed, preferably with a bead of silicon, and the same is true for the two holes that receive the plumbing assemblies 28.

Another favorable aspect of the present invention is that it is adapted to facilitate and to simplify the harvesting of rainwater, particularly via the use of a conventional materials. Aside from the strainer 12 described above, the present invention contemplates the use of a conventional container and conventional plumbing assemblies or fixtures. For instance, FIG. 18 shows the preferred plumbing assembly 28 for use in connection with the present invention.

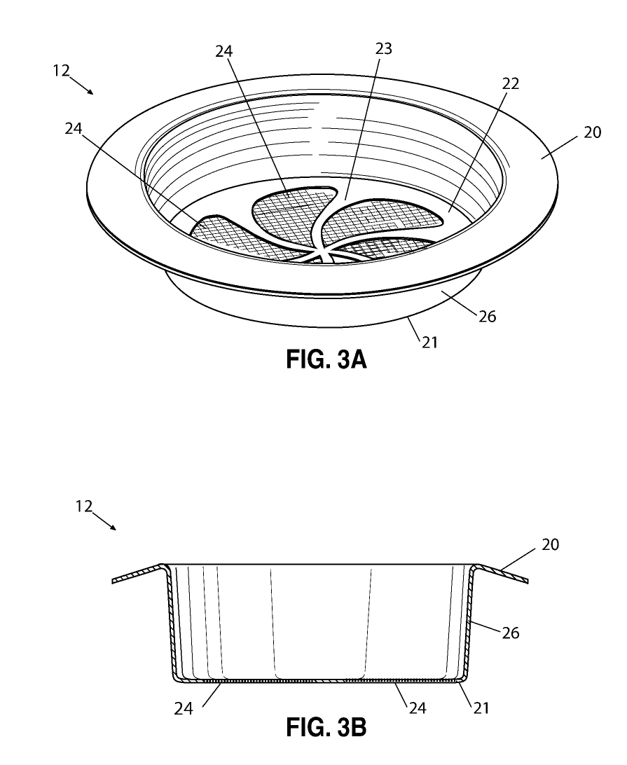

FIG. 18 is an exploded view, to show the relative positions of the components with respect to the wall of the container 32. More particularly, with respect to plumbing assembly 28, fixtures 28D and 28F connect to each other on opposite sides of container 32, so as to sandwich the container 32 therebetween, with O-rings 28E residing therein. The fitting shown on the right side in FIG. 3, namely component 28F, resides in the interior of the container 32. Meanwhile, an external fitting 28C connects to fitting 28D, and resides outside the container 32. The fitting 28C threadably receives a hose (not shown) which is held thereon by a clamping collar 28B and cap 28A.

The plumbing assemblies 28 are equipped with a valve that allows the user to stop and start the water flow, which is especially useful when changing configurations. The assemblies operatively connect to standard garden hose couplings.

Preferably, the system 10 of this invention uses two plumbing assemblies per barrel, both with on/off valves. By providing two fully enabled plumbing assemblies 28 the user has more flexibility and modularity. Either assembly 28, or both, can function as an overflow valve, which can enable the user to control the speed of drainage. Most rain barrels only provide one plumbing assembly.

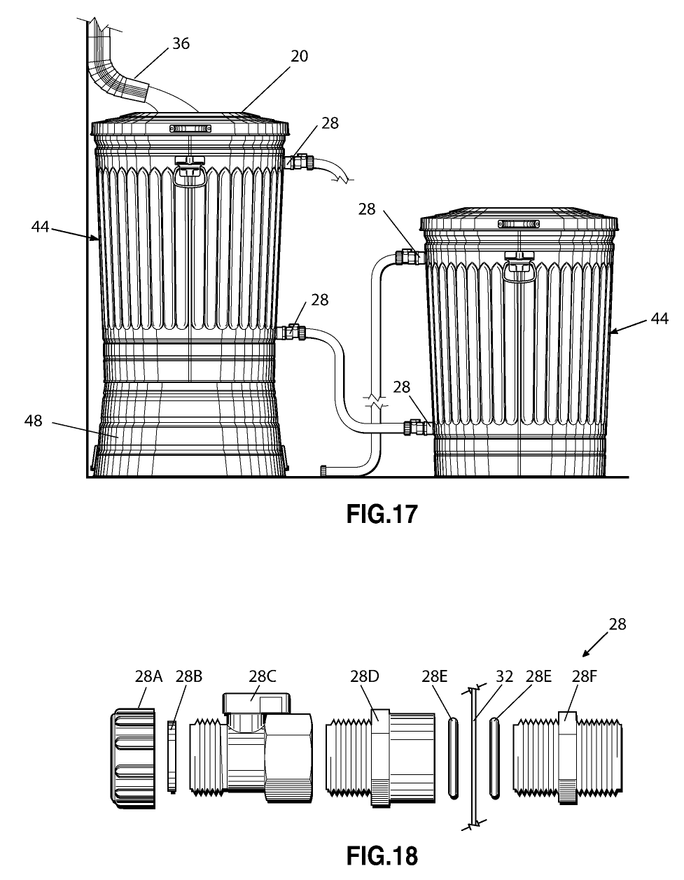

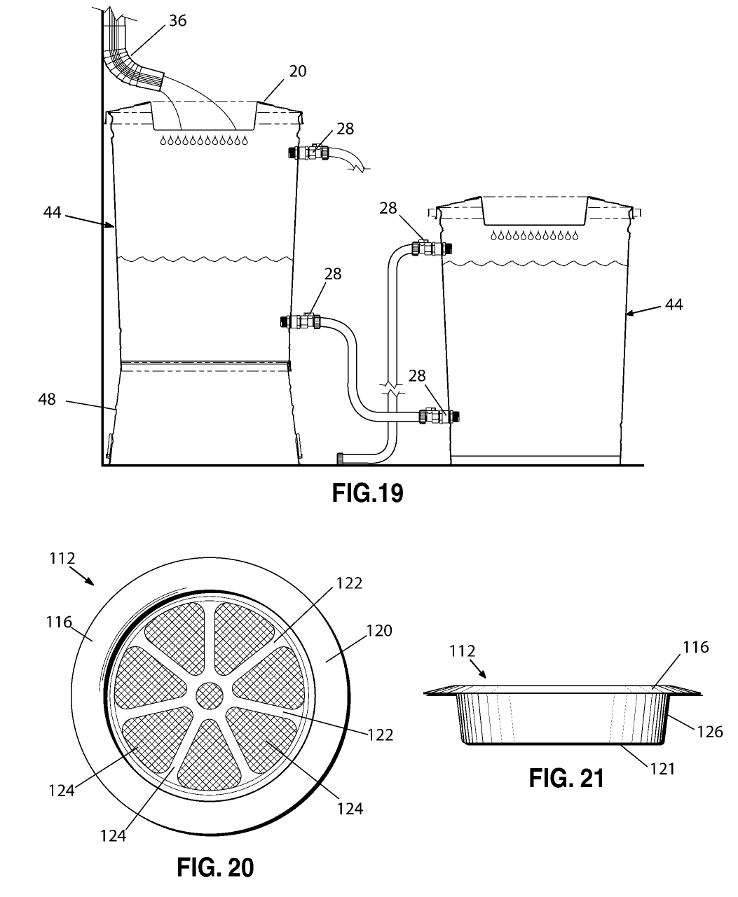

This system 10 is modular and offers a range of possible configurations for collecting and distributing rainwater, as shown in FIGS. 17 and 19. Whether just one barrel or two, with two fully functional plumbing assemblies per barrel, the present invention allows the user a lot of flexibility.

The key to multiple barrel set-up is that the lead barrel must be the highest off the ground, so that gravity will allow the water to flow from the lead collection barrel to the subsequent barrels. These aspects of the invention are best shown by FIGS. 17 and 19.

The invention contemplates further variations on the structure of the basket-like strainer, as indicated by FIGS. 20 and 21. More particularly, FIGS. 20 and 21 show a similarly constructed strainer 112, which includes a top flange 120 and a bottom 121. The bottom 121 comprises reinforcement structure 122, particularly radially oriented spokes 123 which provides support for the mesh 124. As with the other embodiment, the mesh 124 is preferably entirely of one piece, and aligned with the reinforcing structure 122 located at the bottom 121 of the strainer 12, 112.

This rainwater harvesting system 10 of the present invention is designed to be one of the lowest cost solutions to enter the market. By keeping the cost extremely low, yet delivering a high degree functionality, this system 10 encourages more people to get involved in rainwater harvesting. This useful conservation activity will become more widespread if people can make a relatively minor investment and learn first-hand how much water they can recycle.

While this application describes several preferred embodiments of the invention, those skilled in the art will readily appreciate that the described embodiments are merely exemplary in nature, and that the subject matter is not limited to that which is expressly shown or described. Accordingly, applicant wishes to be bound by the claims, not the particular details described as shown in the context of these preferred embodiments.

I claim:

1. A rainwater catchment system comprising:
a container having a top end;
a lid sized to cover the top end, the lid having an opening formed therein defined by an edge;
a strainer removably held by the lid over the opening, and sized and shaped to accommodate the edge of the lid that defines the opening, the strainer including a mesh located below the opening, the mesh adapted to allow the passage therethrough of rainwater and to filter debris from the rainwater when the container is located such that the opening is in the flow path of a rainwater downspout.

2. The rainwater catchment system of claim 1 wherein the strainer further comprises:
an upper flange;
a vertical side wall;
a bottom connected to the side wall, the bottom including the mesh and a reinforcing web.

3. The rainwater catchment system of claim 2 wherein the flange, the side wall, and the reinforcing web are integrally formed, and the mesh is secured to the reinforcing web.

4. The rainwater catchment system of claim 3 wherein the mesh is heat-sealed to at least one of the upper and the lower surfaces of the reinforcing web.

5. The rainwater catchment system of claim 1 wherein the opening and the strainer are circular in shape, and the opening is offset with respect to a center vertical axis of the container.

6. The rainwater catchment system of claim 1 wherein the opening is circular in shape, and the flange is also circular in shape and sized to extend over the edge of the opening about its entire periphery.

7. The rainwater catchment system of claim 2 wherein the reinforcing web includes radially directed spokes.

8. The rainwater catchment system of claim 7 wherein the radially directed spokes are curved and define a flower petal shape.

9. A rainwater catchment system for catching rainwater from a downspout and collecting the caught rainwater in a container, comprising:
a strainer sized to be removably held within an opening at a top end of the container, the strainer further including
an upper flange sized and shaped so as to engage the container at the top end;
a side wall depending downwardly from the flange; and
a mesh, held by the wall at a bottom end thereof, the mesh located at a vertical level below the flange.

10. The rainwater catchment system of claim 9 further comprising
a reinforcing web secured to the mesh and defining the bottom of the strainer, wherein the flange, the side wall, and the reinforcing web are integrally foiuied and the mesh is secured to the reinforcing web.

11. The rainwater catchment system of claim 10 wherein the mesh is heat-sealed to either the upper or the lower surface of the reinforcing web.

12. The rainwater catchment system of claim 9 wherein the strainer is circular in horizontal cross sectional shape.

13. The rainwater catchment system of claim 9 wherein the reinforcing web includes radially directed spokes.

14. The rainwater catchment system of claim 9 wherein the radially directed spokes are curved and define a flower petal shape.

15. The rainwater catchment system of claim 9 further comprising:
a lid held at the top end of the container, the lid having an opening sized to hold the upper flange.

16. The rainwater catchment system of claim 15 wherein the container is one of the following: a conventional 55-gallon plastic drum and a 35-gallon metal trashcan.

17. The rainwater catchment system of claim 9 wherein the strainer is made as one piece, by injection molding a plastic around the mesh, thereby to encase the mesh.

18. The rainwater catchment system of claim 9 wherein the mesh has a mesh size of 400 microns.

19. A method of converting a conventional container into a rainwater catchment system, comprising:
placing a strainer in an opening formed in a lid of the convention container, the opening being of predetermined size and shape, the strainer including an upper flange that is sized and shaped to engage the opening, the strainer further including a lower mesh supported below the flange, whereby with the lid placed on the conventional can and the strainer placed in the opening, and the strainer located so as to be in the flow path of a downspout, rainwater flowing from the downspout flows downwardly through the opening and the mesh for collection in the conventional can.

20. The method of claim 19 further comprising:
forming the opening in the lid prior to the placing.

21. The method of claim 19 further comprising:
removing the strainer from the opening for cleaning, and then placing the strainer back in the opening.

22. The method of any of claim 19 wherein the conventional container is a metal garbage can and further comprising:
sealing the inside bottom edge of the garbage can.

23. The method of claim 19 and further comprising:
mounting a first plumbing fixture to a sidewall of the conventional can, at a desired height, so as to enable selective outflow of collected rainwater from the conventional can.
